(19) United States
(12) Patent Application Publication
(10) Pub. No.: US 2018/0226714 A1
(43) Pub. Date: Aug. 9, 2018

(54) DIELECTRIC TRAVELLING WAVEGUIDE WITH VARACTORS TO CONTROL BEAM DIRECTION

(71) Applicant: AMI Research & Development, LLC, Windham, NH (US)

(72) Inventors: John T. Apostolos, Lyndeborough, NH (US); William Mouyos, Windham, NH (US)

(21) Appl. No.: 15/887,023

(22) Filed: Feb. 2, 2018

Related U.S. Application Data
(60) Provisional application No. 62/454,393, filed on Feb. 3, 2017.

(51) Int. Cl. H01Q 3/24; H01P 3/16; H01Q 1/50

(52) U.S. Cl. CPC H01Q 3/24; H01Q 1/50; H01P 3/16

(57) ABSTRACT

A waveguide formed of two or more dielectric control layers. A varactor layer provides control over the propagation constant, in turn permitting the waveguide to act as a steerable antenna having a controllable beam direction.

### CROSS REFERENCE TO RELATED APPLICATIONS

This application claims priority to a co-pending U.S. Provisional Patent Application Ser. No. 62/454393 filed Feb. 3 2017, entitled “DIELECTRIC TRAVELLING WAVEGUIDE WITH VARACTORS TO CONTROL BEAM DIRECTION”, the entire contents of which are hereby incorporated by reference.

### BACKGROUND

### Technical Field

This application relates to dielectric travelling waveguides that can be used to steer an antenna beam.

### Background

Recent developments have made use of dieletric waveguides to provide functions normally associated with antenna arrays. The waveguides are generally configured as an elongated slab with a top surface, a bottom surface, a feed end, and a load end. The slab may be formed from two or more dielectric material layers such as silicon nitride, silicon dioxide, magnesium fluoride, titanium dioxide or other materials suitable for propagation at a desired frequency of operation.

In one implementation, physical gaps are formed between the layers. A control element is also provided to adjust a size of the gaps. The control element may, for example, be a piezoelectric or electroactive material or a mechanical position control. Changing the size of the adjustable gaps has the effect of changing the effective propagation constant of the waveguide. This in turn allows for scanning the resulting beam at different angles. These devices have been designed for use at radio frequencies, acting as a directional radio antenna, and at visible wavelengths, acting as a solar energy concentrator. See U.S. Pat. No. 8,710,360 and 9,246,230, incorporated by reference herein, for some example implementations of wavguides with configurable gaps.

As explained in those patents, a coupling layer may also be used that has a dielectric constant that changes as a function of distance from the excitation end to the load end. By providing increased coupling between the waveguide and the correction layer in this way, horizontal and vertical mode propagation velocities may be controlled.

Adjacent dielectric layers may be formed of materials with different propagation constants. In those implementations, layers of low dielectric constant material may be alternated with layers of high dielectric constant material. These configurations can provide frequency-independent control over beam shape and beam angle.

The waveguide may also act as a feed for a line array of antenna elements. In some implementations, a pair of waveguides are used. Coupling between the variable dielectric waveguide(s) and the antenna elements can also be individually controlled to provide accurate phasing of each antenna element. See for example U.S. Pat. No. 9,509,056 incorporated by reference herein.

The elements of an antenna array may also be fed in series by a structure formed from a transmission line disposed adjacent a waveguide with reconfigurable gaps between layers. The transmission line may be a low-dispersing microstrip, stripline, slotline, coplanar waveguide, or any other quasi-TEM or TEM transmission line structure. The gaps introduced in between the dielectric layers provide certain properties, such as a variable propagation constant to control the scanning of the array. Alternatively, a piezoelectric or ElectroActive Polymer (EAP) actuator material may provide or control the gaps between layers, allowing these layers to expand, or causing a gel, air, gas, or other material to compress. See U.S. Pat. No. 9,705,199 filed May 1, 2015 incorporated by reference herein for more details.

### SUMMARY

The apparatus described herein is a type of adjustable dielectric travelling wave arrangement that provides a steerable beam without the need for physically movable gaps between the layers. Instead, one or more varactors provide control over the impedance of a waveguide section disposed between two or more layers. The effective propagation constant of the waveguide may then be controlled by changing the voltage on the varactors.

The apparatus may be implemented with multiple substrate layers of the same or different thicknesses. The different thickness layers may be further arranged with a chirp or Bragg spacing to provide frequency independent operation.

Eliminating the movable gaps between layers provides a completely solid state implementation, significantly decreasing the complexity associated with mechanically adjustable physical gaps and providing a corresponding reduced cost of implementation.

### BRIEF DESCRIPTION OF THE DRAWINGS

The description below refers to the accompanying drawings, of which:

FIG. 1 is a cross sectional view of a waveguide with dielectric layers and varactor sections.

FIG. 2 is a more detailed view of the structure of FIG. 1.

FIG. 3A is a more detailed view of the varactor section and bias control surfaces; FIG. 3B is the corresponding electrical circuit diagram.

FIG. 3C and 3D show an example reversed bias PN junction and the resulting effective parallel plate capacitance.

FIG. 3E is a table relating capacitance for a varactor of a given size to dielectric constant for a range of capacitances.

FIG. 4 illustrates a multiple layer implementation with progressively increasing spacing between layers

FIG. 5 is an implementation where multiple waveguides are arranged in parallel to provide control over the beam in three dimensions.

FIGS. 6A and 6B are representative isometric and side views of a waveguide with a mechanically adjustable space or gap between layers.

FIGS. 7 and 8 are curves for different frequencies showing the change in dielectric constant as a function of the gap size for the waveguide in FIGS. 6A and 6B.

FIGS. 9A and 9B are representative isometric and side views of a waveguide implemented with solid state varactors according to the teachings herein.

FIGS. 10A and 10B are more detailed views of a section of the waveguide and varactors.

FIG. 11 illustrates curves for four different frequencies and the resulting change in dielectric constant obtained with the varactor implementation of FIGS. 10A and 10B.

### DETAILED DESCRIPTION OF AN EMBODIMENT

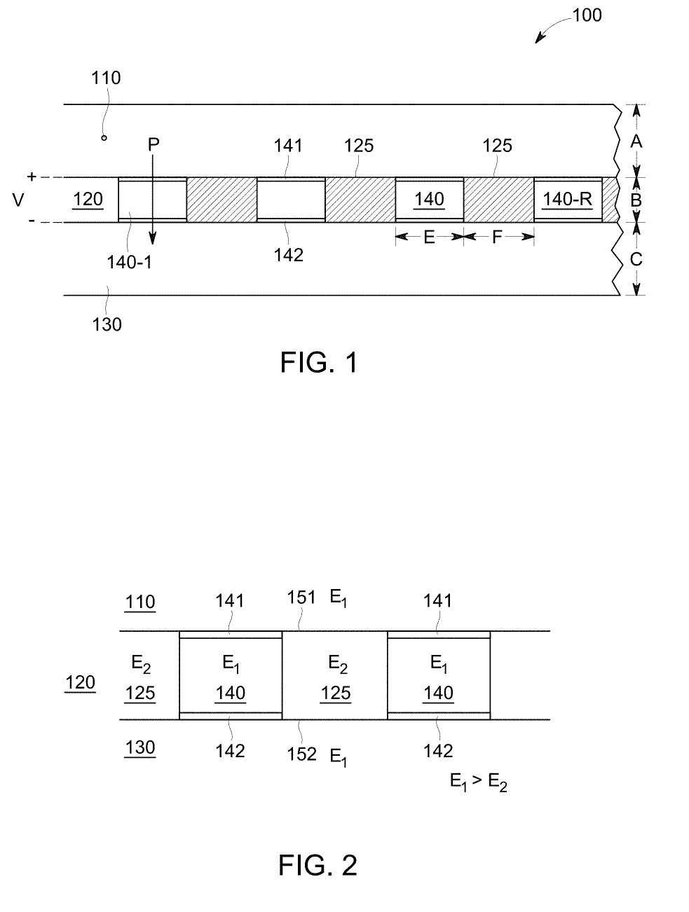

FIG. 1 is a cross sectional view of an example waveguide 100. The waveguide 100 is a generally rectangular cuboid (3-orthotope or six-sided box-shape) formed from multiple dielectric layers including at least a top layer 110, middle layer 120, and bottom layer 130. Top layer 110 and bottom layer 130 are formed of a continuous (homogenous) dielectric material. Typical dielectric materials used for the top layer 110 and bottom layer 130 may include silicon nitride, silicon dioxide, magnesium fluoride, titanium dioxide or other materials suitable for propagation at a desired frequency (e.g., wavelength) of operation. The waveguide is used as an electromagnetic radiation emitter or receiver, and is scaled according to the desired wavelength of operation. For example, in the case of radio frequency operation, the waveguide 100 may operate as an antenna. For operating at shorter wavelengths, such as in the solar energy band, the waveguide may be part of a solar energy collector.

Middle layer 120, also called the varactor layer herein, is formed of a series of alternating sections 125 and sections 140 of different materials having different respective dielectric propagation constants. The sections 125, 140 are a generally elgonated rectangular slab of material. An example first section 140 is formed of a first dielectric material having the same, or nearly the same, propagation constant as layers 110, 130. The first dielectric material may be titantium dioxide. An example second section 125 is formed of a second dielectric having a different propagation constant than the first section 140. The second dielectric material may have relatively lower propagation constant such as silicon dioxide.

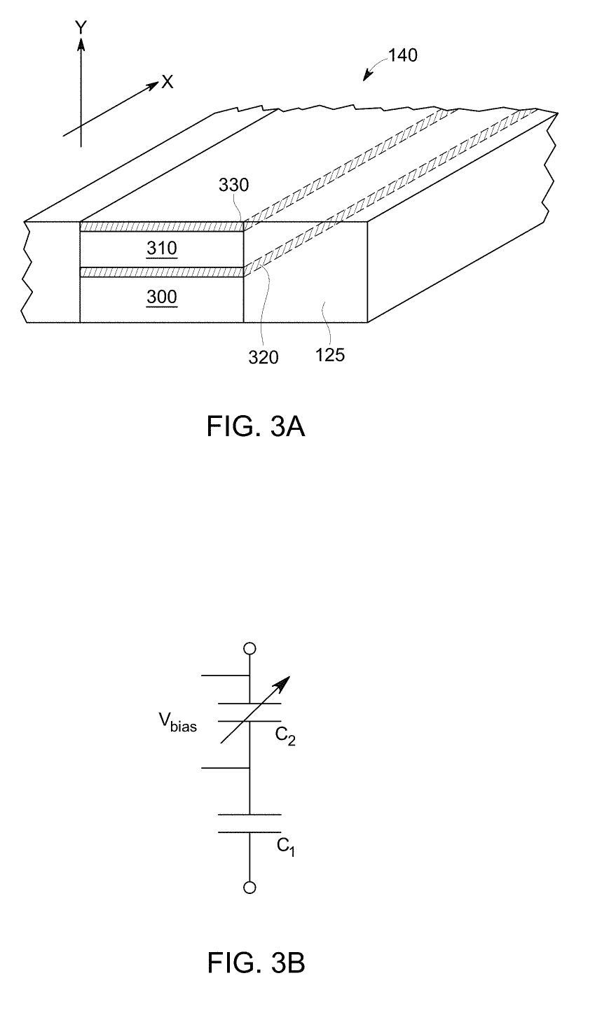

As shown in FIG. 2, layers 110, 130 and sections 140 may have a first propagation constant ε₁, and sections 125 may have a second propagation constant of ε₂. In one implementation, ε₁ is 36 and ε₂ is 2; that is, ε₁ is at least 10 times greater than ε₂. In other implementations, ε₁ may be much higher, such as 100.

Typical dimensions for radio frequency operation at X-band may have the top and bottom layers 110, 130 with respective thickness (A and C) of 0.025 inches, and a varactor layer thickness 120 of 0.0005 inches. The respective widths, E and F, of sections 140 and 125 may each be 0.01 inches.

A material such as Indium Titantium Oide (ITO) is deposited on the top and bottom of sections 140 such as at 141, 142 to provide a varactor. A control or biasing circuit (not shown) imposes a controllable voltage difference, V, on 141, 142. It should also be understood that conductive traces are deposited on one or more of the layers to connect the varactors to the control circuit (also not shown).

The control voltage V applied to the varactor thus changes the impedance of a path, P, from the upper waveguide 110, through the dielectric section 140 to the lower waveguide 130. When that control voltage, V, is relatively high, the dielectric sections 140 become more connected to the adjacent layers 110, 130—that is, the impedance through path P is relatively lower. When that voltage difference is relatively smaller, the impedance through path P becomes relatively higher.

Changing the voltage V thus changes the overall propagation constant of the waveguide 100. The voltage V can thus be used to steer the resulting beam.

In some implementations, there may be further control over the voltages applied to different ones of the sections 140 to provide a different impedance of the waveguide structure as a function of horizontal distance. That approach can provide the same properties as the wedge or taper layers described in the patents and patent applications referenced above.

One can also control the amount of dispersion in the waveguide 100 by controlling the spacing F between the varactor sections 140. Spacing them at a fraction of the operating wavelength (λ) of about λ/10 apart appears to be preferable, although λ/4 would provide more dispersion.

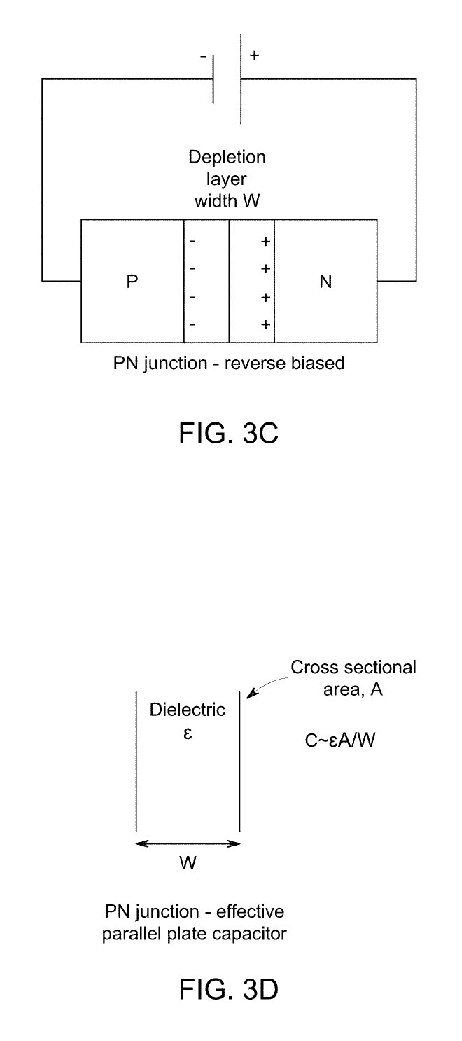

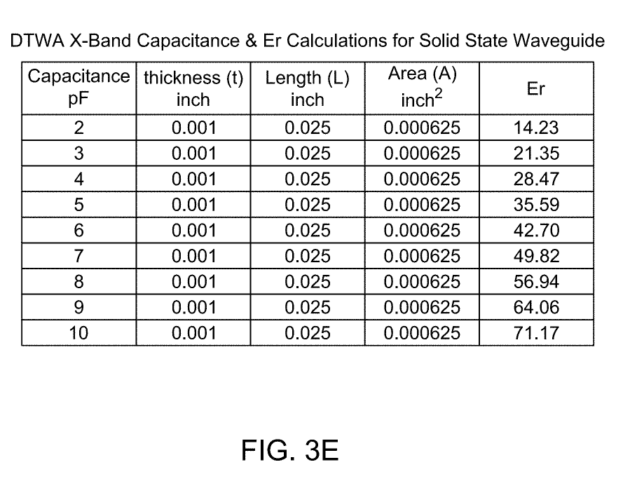

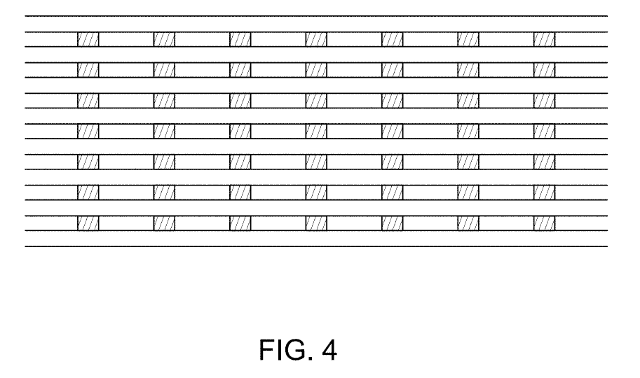

FIG. 3A is a detailed isometric view of an implementation showing a varactor section 140 and adjacent section 125 in more detail. Each section 125, 140 is a generally rectangular element, elongated in shape such that its overall length is greater than its cross-sectional width or height. Here varactor section 140 consists of a bottom portion 300 having the relatively high propagation constant ε_{rhigh.} such as 100, as previously metioned. An upper portion 310 consists of a reverse biased semiconductor junction material such as a gallium arsenide PN junction. Conductive layer 320 is disposed between lower dielectric portion 300 and upper portion dielectric 310, (adjacent a bottom face) and a second conductive layer 330 is disposed above upper portion 310 (adjacent a top face). Conductive layers 320, 330 (also referred to as biasing layers herein) serve to control the voltage across the PN junction of upper portion 310 and thus to control the capacitance.

Although FIG. 3A shows the PN junction formed at the upper edge of varactor section 140, it is also possible to position PN junction in the middle, somewhat evenly spaced between the upper and lower edges.

An equivalent circuit to varactor section 140 is shown in FIG. 3B. Fixed capacitance C₁ is provided by bottom portion 300 and variable capacitance C₂ is provided by the conductive layers 320, 330 on either side of the upper dielectric portion. The conductive layers 320, 330 serve to provide a connection to a biasing voltage source (not shown.) Varying this control voltage thus changes the capacitance of the path from the upper waveguide through the higher dielectric slab to the lower waveguide, resulting in an alternating impedance as a function of distance along the waveguide.

We have determined that the presence of conductive layers 320, 330 does not interfere with the propagation modes of the dielectric waveguide sections. The total impedance of the two capacitors in series is thus (C₁C₂/(C₁+C₂).

FIGS. 3C and 3D shows the effective parallel plate capacitance provided by a reverse biased PN junction having cross sectional area A, depletion area width W (as controlled by bias voltage V) and propogation constant ε of the junction material).

FIG. 3E is a table of capacitance values for a cross sectional area A of 0.000625 inches (thickness 0.001 in and length 0.025 in), showing a resulting range of capacitances from 2 pF to 10pF providing propagation constants ranging from 14.23 to 71.17.

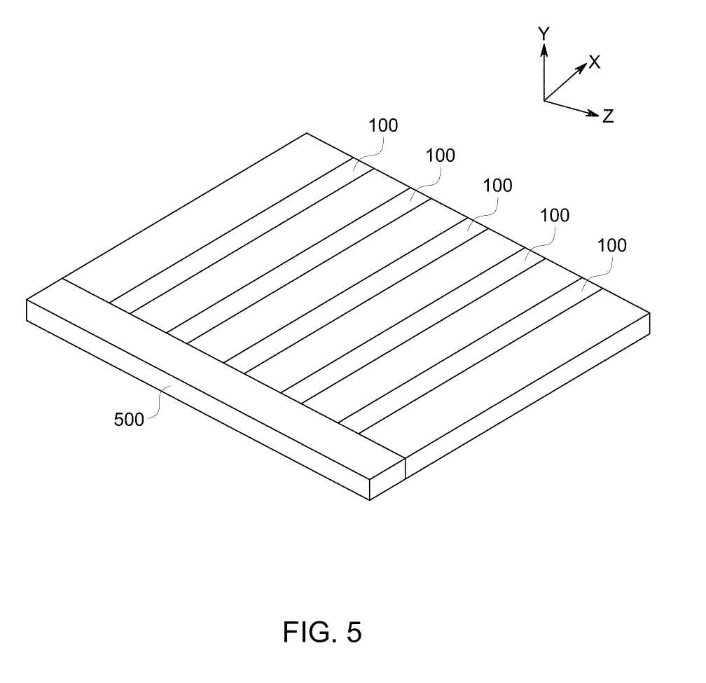

FIG. 4 illustrates an implementation similar to that of FIG. 1 but with more than three top, middle, and bottom layers 110, 120, 130. Here the layers 110, 130 and 120 have progressively larger thickness, although implementations with multiple layers 110, 130 and 120 with uniform thickness is also possible. The relative increase in thickness can follow a proscribed pattern, such as a chirped or Bragg pattern, as described in the patents and patent applications referenced above.

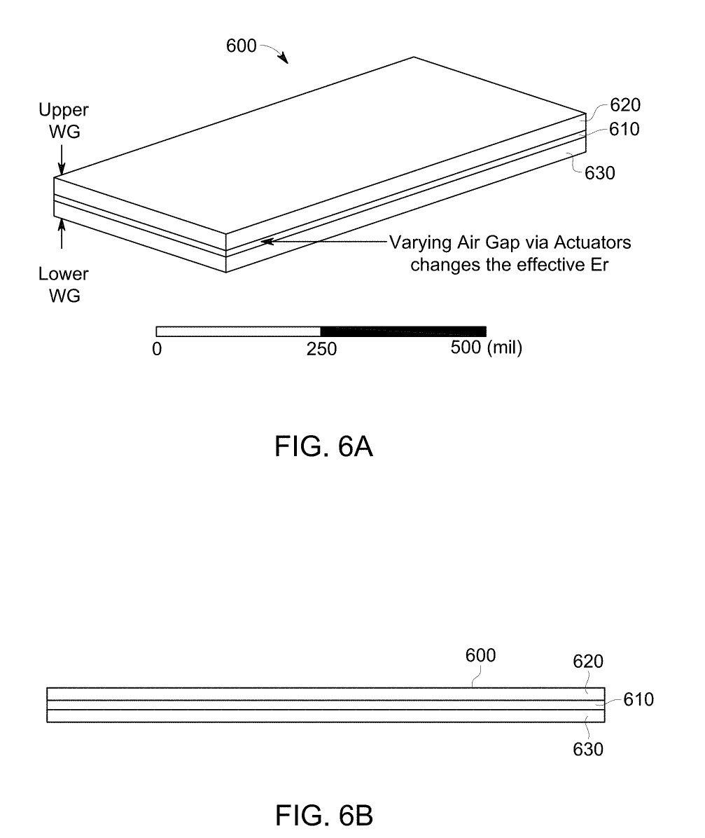

A single waveguide such as shown in FIGS. 1 and 3A provides a steerable broadside beam steerable in elevation, that is in an x,y plane perpendicular to its top face (see FIG. 3A for the relative position of the x- and y-axes of that plane). However steering in three dimensions is possible using multiple parallel wavguides 100 spaced along a z-axis as shown in FIG. 5. The multiple parallel waveguides 100 may be fed by another waveguide 500 disposed transversely to the parallel waveguides 100. Progressive delays and/or phase shifts may be provided along the set of waveguides to this end, such that each waveguide has a delay or phase shift compared to its neighboring waveguides. See U.S. Pat. No. 9,246,230 mentioned previously for other examples of using multiple parallel waveguide sections.

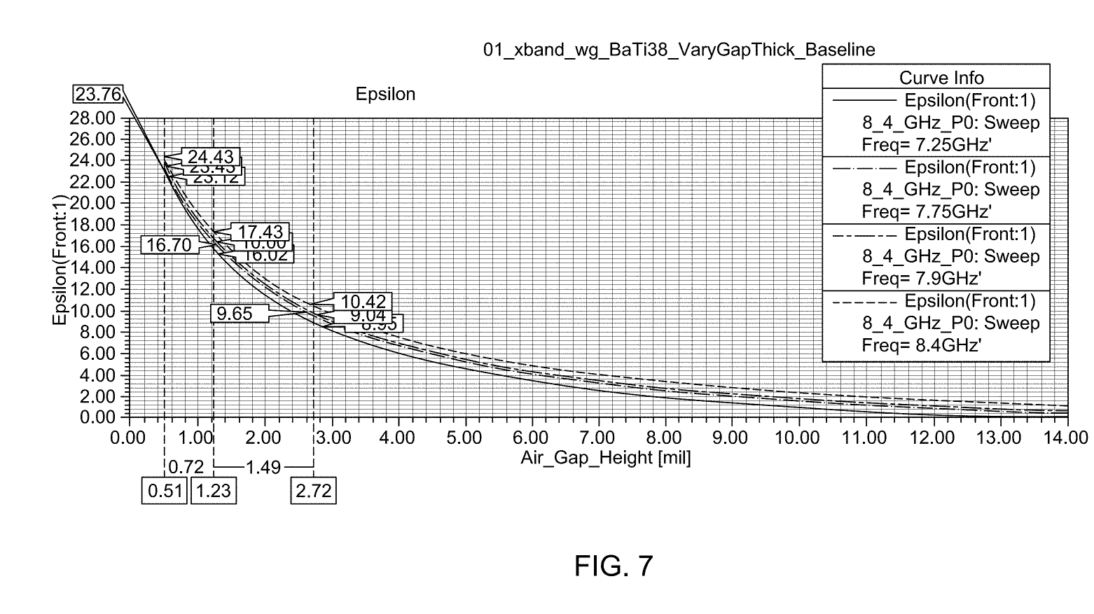

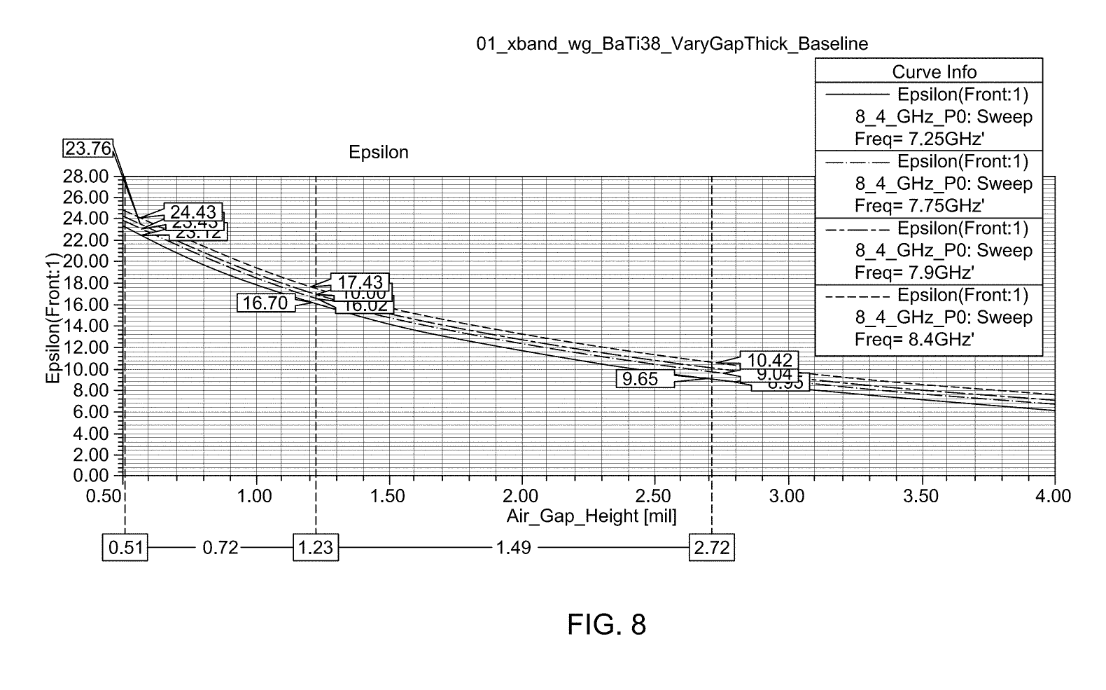

FIGS. 6A and 6B are representative isometric and side views of a waveguide 600 with a mechanically adjustable space or gap between upper waveguide layer 620 and lower waveguide layer 630. This structure was modeled to estimate the effect of a change in gap size on the effective overall effective dielectric constant εᵣ FIG. 7 is the result modeled for four frequencies (7.25 GHz, 7.75 GHz, 7.9 GHz and 8.4 GHz) as the gap size was varied from 0.5 mil to 14 mil. FIG. 8 is a closer view of the same curves between 0.5 and 2.7 mil. The resulting difference in dielectric constant εᵣachieved of 3:1 (e.g., between about 24 to about 8) should provide control of the beam over +/−45 degree angle.

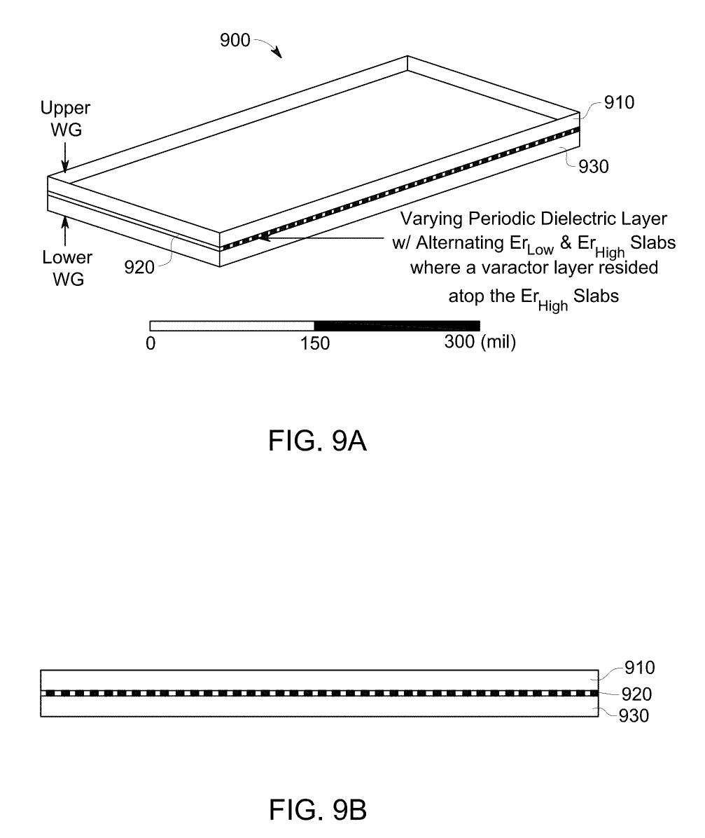

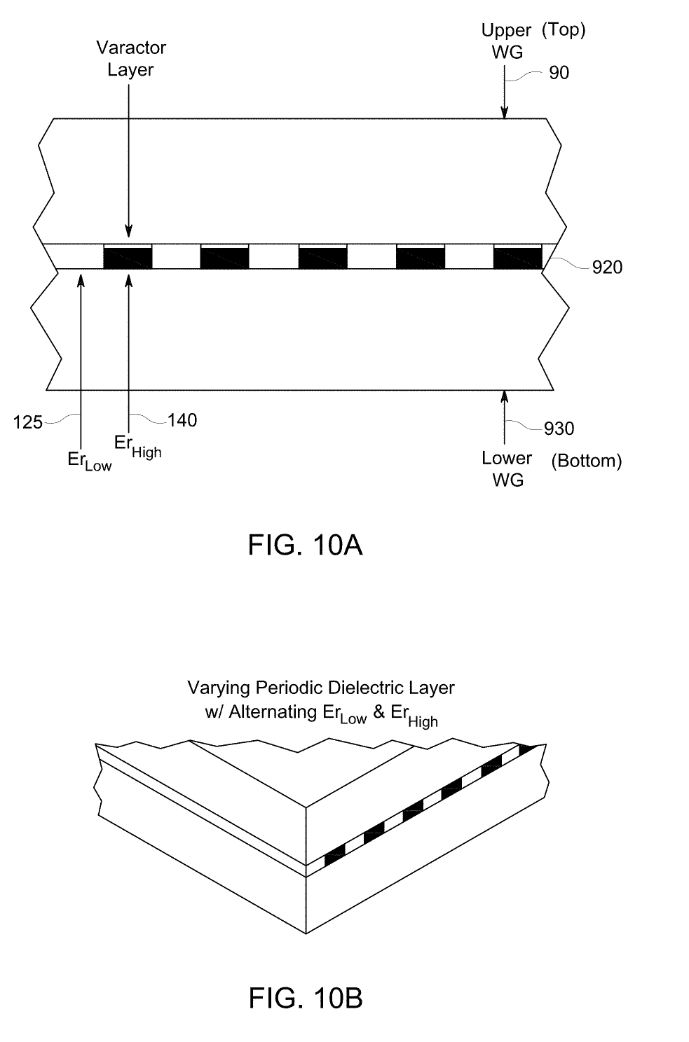

FIGS. 9A and 9B are representative isometric and side views of a waveguide 900 having a top layer 910 and bottom layer 930 with with a middle layer 920 consisting of varying periodic dielectric sections e.g., the alternating ε_{rlow} and ε_{rhigh} sections 125, 140 with varactors as described above. FIGS. 10A and 10B are more detailed views of a section of the waveguide 900, layers 910, 930, sections 125, 140 and varactors as modelled.

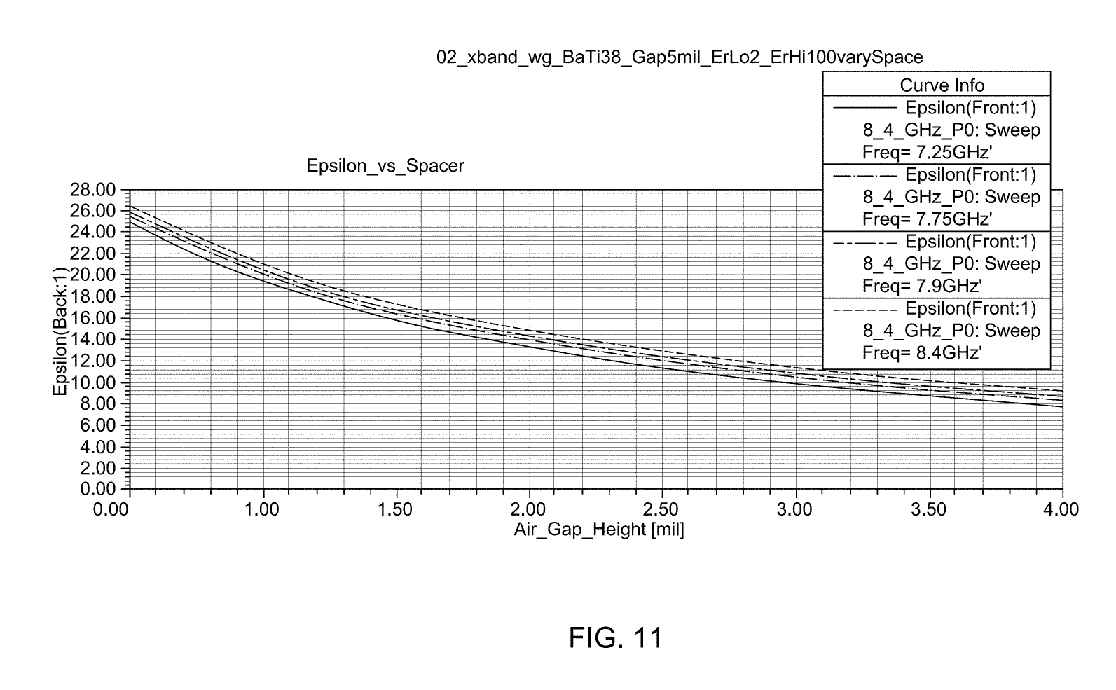

FIG. 11 illustrates resulting estimate of the change in ε for the same four frequencies (7.25 GHz, 7.75 GHz, 7.9 GHz and 8.4 GHz) as the capacitance is varied (here the equivalent spacing or “gap” size on the horizontal axis was actually provided by varying the “capacitance” presented by the reverse biased PN junction. It is seen that again, a 3:1 variance in dielectric constant is achievable.

In the embodiments described above, the bias voltages applied would typically be the same for all varactors in a given waveguide 100, 900. However, we have realized that these voltages can be controlled in other ways, such as by a progressive increase or decrease in voltage. For example, with reference to FIG. 1, a lower biasing voltage may be applied to the leftmost varactor section 140-1 than its neighbotr140-2, and the voltage applied to section 140-3 might be higher still. By applying a progressive gradient in voltages an effect similar to the physical wedge described in the above referenced U.S. Pat. No. 9,246,230 can be provided.

In another implemention, increased bandwidth can be provided by providing more than one middle layers 120, with each middle layer 120 having a different effective propagation constant.

The waveguide 100 can also be used to feed antenna arrays of different types. For example, waveguide 100 may be used to feed one of the Orientation Independent Antennas described in U.S. Pat. No. 8,988,303 and 9,013,360 as well as U.S. patent application Ser. No. 15/362,988 filed Nov. 29, 2016 all of which are hereby incorporated by reference.

What is claimed is:

1. An apparatus comprising:
a dielectric waveguide formed of at least a first layer and a second layer;
a varactor coupled to the first and second layers; and
a control circuit coupled to control a voltage applied to the varactor.

2. The apparatus of claim 1 where a third layer is disposed between the first and second layers, and the third layer comprises a plurality of alternating sections formed of dielectric material with different propagation constants, with a selected subset of the sections providing two or more varactors.

3. The apparatus of claim 1 where the waveguide is used as a feed for a plurality of antenna elements.

4. The apparatus of claim 1 where the varactor is formed from a reverse biased PN junction.

5. The apparatus of claim 1 where the varactor further comprises:
an elongated element having a rectangular cross section composed of a semiconductor material and having a top face and a bottom face opposide the top face;
a first conductive section disposed adjacent the top face; and
a second conductive section disposed adjacent the bottom face.

6. The apparatus of claim 2 where a same bias voltage applied to the two or more varactors.

7. The apparatus of claim 2 where different bias voltages are applied to the two or more varactors.
